(19) United States
(12) Patent Application Publication
(10) Pub. No.: US 2011/0140628 A1
(43) Pub. Date: Jun. 16, 2011

(54) POWER SUPPLY FOR LIGHTING LUMINARY FOR IMPROVING DIMMING PERFORMANCE

(76) Inventors: Guang-Ming LEI, Taoyuan City (TW); Yu Hsien Cheng, Taoyuan City (TW)

(21) Appl. No.: 12/637,111

(22) Filed: Dec. 14, 2009

(51) Int. Cl. H05B 41/16

(52) U.S. Cl. 315/287

(57) ABSTRACT

A power supply for a lighting luminary for improving dimming performance is disclosed. The power supply is applied to an AC source, a TRIAC dimmer, and at least one lighting luminary. The power supply includes a half-wave rectifier, an input voltage detector, a dimming signal generator, a feedback circuit, and a DC-to-DC converter. The input voltage detector is electrically connected to the half-wave rectifier. The dimming signal generator is electrically connected to the input voltage detector. The feedback circuit is electrically connected to the dimming signal generator. Besides, the DC-to-DC converter is electrically connected to the half-wave rectifier. More particularly, the half-wave rectifier provides a single-direction current path to avoid turning off the TRIAC dimmer during the dimming process because of the alternating positive and negative half cycles of the AC source.

### BACKGROUND OF THE INVENTION

1. Field of the Invention

The present invention relates to a power supply for a lighting luminary, and more particularly to a power supply for a lighting luminary for improving dimming performance.

2. Description of Prior Art

At present, most of the TRIAC dimmers could not be normally turned on unless adjusting them to at least 30% maximum illumination thereof. Also, the illumination could be adjusted under 30% maximum illumination only when the TRIAC dimmer has been turned on. More particularly, the TRIAC dimmer could be turned off when the conduction angle is small enough. Hence, it is not easy to adjust the TRIAC dimmer to the lighting luminary operate at the minimum illumination because of considering the conduction angle.

Reference is made to FIG. 2 which is a circuit diagram of a prior art TRIAC dimmer. The TRIAC dimmer is shown inside the dotted line. A conduction angle A1 of the voltage across a load resistor RL can be varied by adjusting value of a variable resistor R1. Namely, the conduction angle A1 is larger when value of the variable resistor R1 is smaller; the conduction angle A1 is smaller when value of the variable resistor R1 is larger. The voltage waveform across the load resistor RL is shown in FIG. 3.

Reference is made to FIG. 4 which is a block diagram of a prior art power supply for a lighting luminary. The prior art power supply for a lighting luminary 100A is applied to an AC source 10A, a TRIAC dimmer 20A, and at least one lighting luminary 50A. The power supply for a lighting luminary 100A includes a full-wave rectifier 30A, a DC-to-Dc converter 40A, an input voltage detector 60A, a feedback circuit 70A, and a dimming signal generator 80A. The full-wave rectifier 30A is electrically connected to the TRIAC dimmer 20A, the DC-to-DC converter 40A, and the input voltage detector 60A. Besides, the feedback circuit 70A is electrically connected to the DC-to-DC converter 40A and the dimming signal generator 80A.

Reference is made to FIG. 2 again. The conduction angle of the prior art TRIAC dimmer needs at least 50 degrees to normally turn on the TRIAC dimmer. Also, the conduction angle could be adjusted less than 50 degrees only when the TRIAC dimmer has been turned on. More particularly, the TRIAC dimmer could be turned off when the conduction angle is small enough. Hence, it is not easy to adjust the TRIAC dimmer to the lighting luminary operated at the minimum illumination because of the conduction angle limitation. Once the conduction angle is small enough to turn off the TRIAC dimmer, the above-mention adjust process will be repeated. The full-wave rectifier 30 can not enable a capacitor C1 to store enough energy to turn on the TRIAC dimmer because of the alternating positive and negative half cycles of the AC source.

Usually, rectifiers includes diodes, which have longer reverse recovery time, the reverse current is excessively large when the diode turn off. More particularly, reverse current of the diode is excessively large to probably to turn off the TRIAC dimmer and blink the lighting luminary.

### SUMMARY OF THE INVENTION

In order to improve the disadvantages mentioned above, the prevent invention provides a power supply for a lighting luminary for improving dimming performance.

In order to achieve an objective mentioned above, the power supply for the lighting luminary for improving dimming performance is applied to an AC source, a TRIAC dimmer, and at least one lighting luminary. The power supply includes a half-wave rectifier, an input voltage detector, a dimming signal generator, a feedback circuit, and a DC-to-DC converter. The input voltage detector is electrically connected to the half-wave rectifier. The dimming signal generator is electrically connected to the input voltage detector. The feedback circuit is electrically connected to the dimming signal generator. The DC-to-DC converter is electrically connected to the half-wave rectifier. More particularly, the half-wave rectifier provides a single-direction current path to avoid turning off the TRIAC dimmer during the dimming process because of the alternating positive and negative half cycles.

In order to improve the disadvantages mentioned above, the prevent invention provides a power supply for a lighting luminary for improving dimming performance

In order to achieve another objective mentioned above, the power supply for the lighting luminary for improving dimming performance is applied to an AC source, a TRIAC dimmer, and at least one lighting luminary. The power supply includes a rectifier, an input voltage detector, a dimming signal generator, a feedback circuit, and a DC-to-DC converter. The rectifier has a super fast diode. The input voltage detector is electrically connected to the rectifier. The dimming signal generator is electrically connected to the input voltage detector. The feedback circuit is electrically connected to the dimming signal generator. The DC-to-DC converter is electrically connected to the rectifier. More particularly, reverse current of the super fast diode is not excessively large to avoid abnormally turning off the TRIAC dimmer and blinking the lighting luminary.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a power supply for a lighting luminary for improving dimming performance according to the present invention;

FIG. 2 is a circuit diagram of a prior art TRIAC dimmer;

FIG. 3 is a voltage waveform graph of an prior art load resistor;

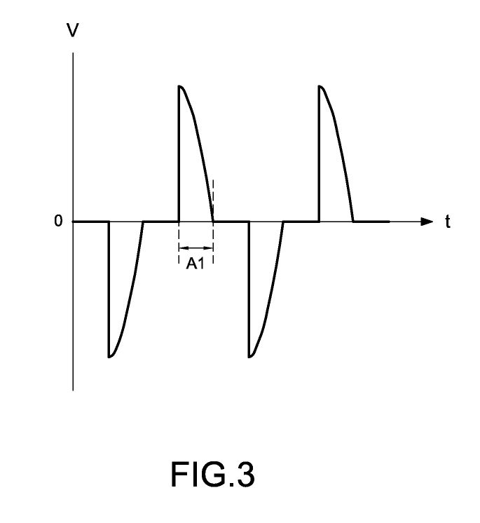

FIG. 4 is a block diagram of a prior art power supply for a lighting luminary; and

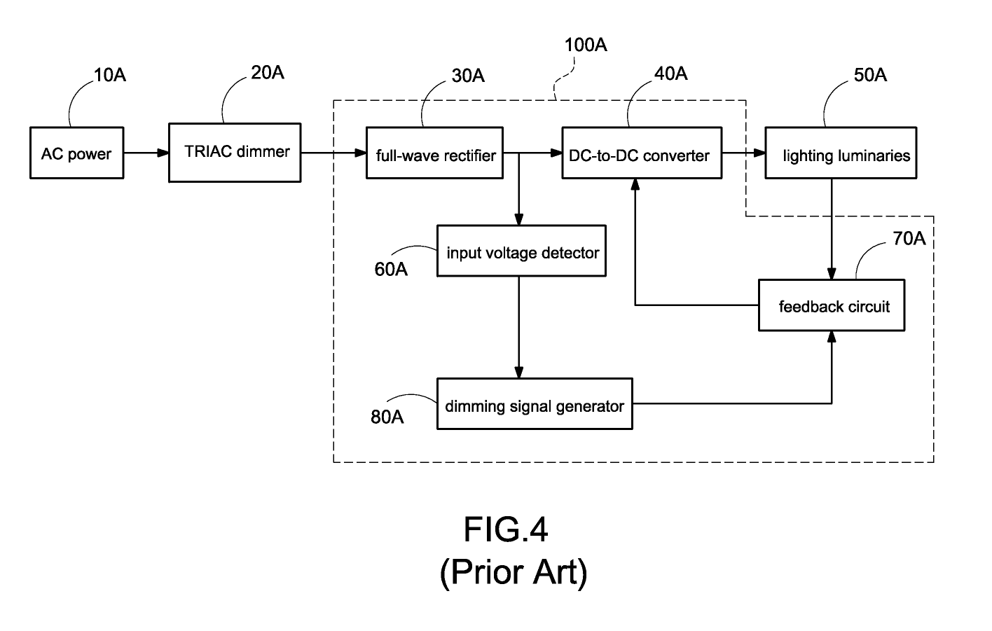

FIG. 5 is a circuit diagram of an embodiment of a half-wave rectifier.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

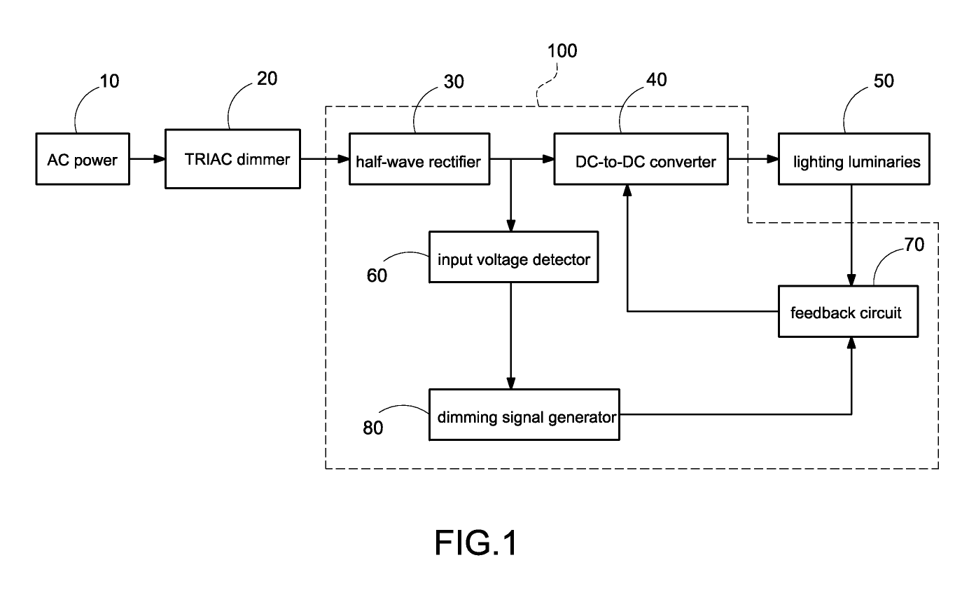

Reference will now be made to the drawing figures to describe the present invention in detail. Reference is made to FIG. 1 which is a block diagram of a power supply for a lighting luminary for improving dimming performance according to the present invention. The power supply for the lighting luminary for improving dimming performance 100 is applied to an AC source 10, a TRIAC dimmer 20, and at least one lighting luminary 50. The power supply for the lighting luminary for improving dimming performance 100 includes a half-wave rectifier 30, an input voltage detector 60, a dimming signal generator 80, a feedback circuit 70, and a DC-to-DC converter 40.

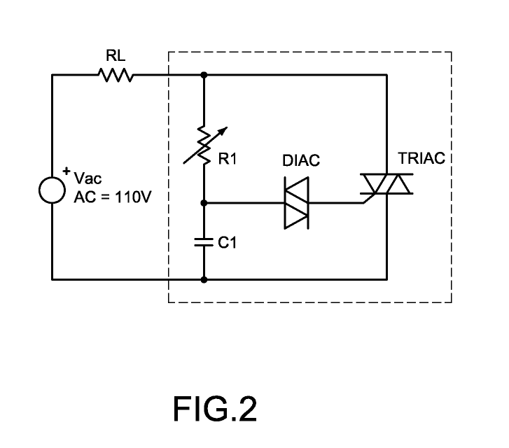

The input voltage detector 60 is electrically connected to the half-wave rectifier 30, the DC-to-DC converter 40, and the dimming signal generator 80. The feedback circuit 70 is electrically connected to the DC-to-DC converter 40 and the dimming signal generator 80. The half-wave rectifier 30 provides a single-direction current path to avoid turning off the TRIAC dimmer 20 during the dimming process because of the alternating positive and negative half cycles of the AC source 10. Reference is made to FIG. 2 again. The half-wave rectifier 30 can enable a capacitor C1 to store enough energy therein to turn on the TRIAC dimmer 20 regardless of value of the variable resistor R1. Namely, the conduction angle is large enough to keep the TRIAC dimmer 20 turn on.

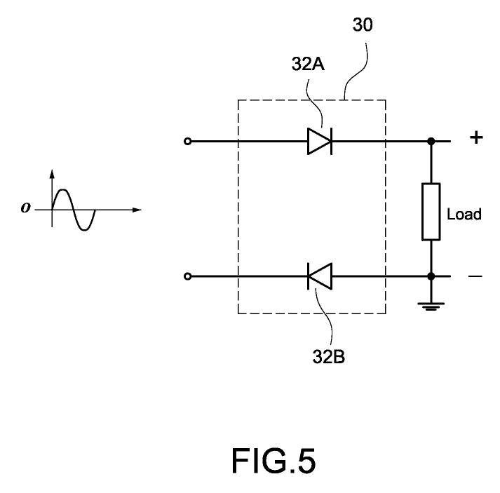

Reference is made to FIG. 5 which is a circuit diagram of an embodiment of a half-wave rectifier. The half-wave rectifier 30 includes a super fast diode 32A and a super fast diode 32B. The super fast diode 32A is electrically connected to the super fast diode 32B. Because reverse recovery times of the super fast diode 32A and the super fast diode 32B are both less than or equal to 150 nanoseconds, reverse currents of the two super fast diodes 32A, 32B are not excessively large when the two super fast diodes 32A, 32B are turn-off. Namely, reverse current of the super fast diode 32A, 32B are not excessively large to avoid abnormally turning off the TRIAC dimmer 20 and blinking the lighting luminary. However, the half-wave rectifier 30 can still operate normally when only the super fast diode 32A is used (namely, the super fast diode 32B is absent).

In conclusion, the present invention has following advantages:

1. The half-wave rectifier 30 is provided to rapidly turn on the lighting luminary and keep large enough conduction angle of the TRIAC dimmer 20 to avoid turning off the TRIAC dimmer 20 during the dimming process to increase flexibility of designing the dimming circuit and illumination performance.

2. The super fast diodes 32A, 32B are provided to avoid blinking the lighting luminary. Although the present invention has been described with reference to the preferred embodiment thereof, it will be understood that the invention is not limited to the details thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power supply for a lighting luminary for improving dimming performance, which applied to an AC source, a TRIAC dimmer, and at least one lighting luminary, and the power supply comprising:
a half-wave rectifier;
an input voltage detector electrically connected to the half-wave rectifier;
a dimming signal generator electrically connected to the input voltage detector;
a feedback circuit electrically connected to the dimming signal generator; and
a DC-to-DC converter electrically connected to the half-wave rectifier;
wherein the half-wave rectifier provides a single-direction current path, whereby during the dimming process, the turning off the TRIAC dimmer due to the alternating positive and negative half cycles can be avoided.

2. The power supply for the lighting luminary in claim 1, wherein the half-wave rectifier comprises at least one super fast diode.

3. The power supply for the lighting luminary in claim 2, wherein reverse recovery time of the super fast diode is less than or equal to 150 nanoseconds.

4. A power supply for a lighting luminary for improving dimming performance, which applied to an AC source, a TRIAC dimmer, and at least one lighting luminary, and the power supply comprising:
a rectifier having a super fast diode;
an input voltage detector electrically connected to the rectifier;
a dimming signal generator electrically connected to the input voltage detector;
a feedback circuit electrically connected to the dimming signal generator; and
a DC-to-DC converter electrically connected to the rectifier;
wherein reverse current of the super fast diode is not excessively large to avoid abnormally turning off the TRIAC dimmer and blinking the lighting luminary.

5. The power supply for the lighting luminary in claim 4, wherein reverse recovery time of the super fast diode is less than or equal to 150 nanoseconds.
